(19) United States
(12) Patent Application Publication
(10) Pub. No.: US 2004/0202209 A1
(43) Pub. Date: Oct. 14, 2004

(54) Quasi-phase-matching photodynamic therapy (PDT) and photodynamic diagnosis ( PDT) laser sources

(75) Inventors: Yen-Chieh Huang, Hsinchu (TW); Yen-Yin Lin, Taipei (TW); Chin-Tin Chen, Taipei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Applied Biophotonics Corp., Taipei (TW)

(21) Appl. No.: 10/821,369

(22) Filed: Apr. 9, 2004

(30) Foreign Application Priority Data
Apr. 11, 2003 (TW) 092108482

(51) Int. Cl. H01S 3/10

(52) U.S. Cl. 372/21

(57) ABSTRACT

A laser system providing a laser source suitable for medical PDT (Photodynamic Therapy) and PDD (Photodynamic Diagnosis) is purposed. The laser system includes a pump laser emitting at least one wavelength to pump a wavelength converter inside a laser resonating system; a wavelength converter using QPM (Quasi-Phase-Matching) technique to convert the wavelength emitted by the pump laser to at least one wavelength suitable for the PDT and the PDD; a laser resonating system for enhancing the output intensity of the laser suitable for the PDT and the PDD generated from the wavelength converter pumped by the pump laser; and an optical transmission and output device for receiving and transmitting the output laser from the laser resonator system to its end optical output component, through which at least one specific target is illuminated.

### FIELD OF THE INVENTION

The present invention is a laser system employing quasi-phase-matching nonlinear frequency conversion for applications in photodynamic therapy (PDT) and photodynamic diagnosis (PDD).

### BACKGROUND OF THE INVENTION

Cancer has been the primary cause of death around the world. Effective diagnosis and therapy in the early stage of cancer development are important in curing cancer. One effective diagnosis technique is related to the use of a fluorescent diagnosing method, called photodynamic diagnosis (PDD). The PDD technique usually employs externally injected fluorescent dyes as fluorescence tags to cancer cells under light illumination of certain wavelengths.

The commonly used photosensitive medicines, such as HpDs (Hematoporphyrin derivatives) and the precursor medicine ALA (5-aminolevulinic acid) for hem-biosynthesis, always have a higher accumulation and a longer retention period on tumors because of the sensitivity to the tissue proliferation and the metabolism. The photosensitive medicine emits fluorescence after absorbing a light of certain wavelengths. Therefore, the photosensitive medicine is used to help diagnosis and furthermore show an image of the tissue which has pathological changes.

A specific optical detection system combined with the photosensitive medicines, such as HpDs and ALA, has been proved useful for early and effective diagnoses for cancers. For example, some photosensitive medicine emits red light when it is excited by blue light at wavelengths of 405˜415 nm. The red light can be easily detected by, say, a silicon detector.

Photodynamic therapy (PDT) is a novel and reliable curing method for cancers. In PDT, a photosensitive medicine is applied to a cancer tumor and the tumor tissue is illuminated by a light source of a particular wavelength. The cancer cells are killed under a light induced chemical reaction. Such photosensitive chemicals are usually chemically inert, having a selective affinity to the tumor tissue and absorb the light having a specific wavelength. It is believed that the cell killing mechanism in PDT is through light induced photochemical reaction in cancer cells in conjunction with the photosensitizer. Hence, the PDT is unharmful to normal cells. The curative effect depends on the tumor orientation of the chemical, the concentration and distribution of the chemicals, the oxygen content and the light absorption efficiency of the chemicals.

In the past tens of years, the development of the second generation photosensitive chemicals and the optoelectrical technology has contributed the PDT for cancer therapy. In many countries, the photosensitive chemical, PhotofrinR, has been approved for curing the epithelium bladder cancer, the esophagus cancer, the early lung cancer, the gastric cancer, and the cervical cancer and so on. Moreover, the US Food and Drug Administration (FDA) has approved the PDT using photosensitive chemicals of LevulanR and VisudyneR for clinically curing the tinea and the age-related macular disease, respectively. In other words, the PDT has been integrated in the omnibearing cure system for its unique advantages of the repeatable photosensitive chemical applying and optical illuminating treatment.

Incoherent light sources, such as an xenon lamp or a halogen lamp usually have a broad emission spectrum and are often used in conventional PDT and PDD. However, thermal problems from the board emission spectrum are disadvantageous when an incoherent optical source is used. Additionally, an optical filter, which reduces the unnecessary power for diagnosis and therapy. is necessary to be installed.

Generally speaking, it is difficult to focus and transmit an incoherent light to a specific target. As a result, the incoherent optical source is replaced by a semiconductor laser, which has a higher power at specify wavelength and a better transmission ability. However, the wavelength and the wavelength tuning ability of the semiconductor laser limited by the characteristics of the semiconductor material. Normally, the wavelength tuning ability of the semiconductor laser, which is compared with a nonlinear frequency conversion, is poor. Therefore, it is also difficult to obtain a semiconductor laser at a specific wavelength, which is suitable for the specific photosensitive chemical. Moreover, there is also a serious problem of heat dissipating when the semiconductor laser is operated under a condition of a high power.

According to the above description, a wavelength tunable optical source necessary for the PDD and the PDT to improve the accuracy and sensitivity of the diagnosis and the scope and profundity of the therapy. In order to overcome the drawbacks in the prior art, a laser system suitable for the PDD and the PDT is disclosed.

### SUMMARY OF THE INVENTION

The main purpose of the present invention is to provide a laser system. The laser system provided in the present invention using a quasi-phase-matching (QPM) technique to emit a laser beam, which has a convertible and adjustable wavelength, is used in the Photodynamic Therapy (PDT) and the Photodynamic Diagnosis (PDD) to improve the accuracy and sensitivity of the diagnosis and the scope and profundity of the therapy.

According to one aspect of the present invention, a laser system especially for a laser source used in the PDT and the PDD includes a pump laser emitting at least a laser beam with a specific wavelength; a wavelength converter converting the specific wavelength of the laser beam emitted by the pump laser into a wavelength adapted to the PDT and the PDD; and an optical transmitting and outputting device receiving and transmitting the laser beam for illuminating at least a specific target through an optical outputting device located at end of the laser system.

In accordance with the present invention, the laser system further includes a first coupling lens located between the pump laser and the wavelength converter for passing through the laser beam.

Preferably, the first coupling lens has an anti-reflecting surface coating, a specific radius of curvature and a specific focal length to receive and coincide the energy of the laser beam from the pump laser to the wavelength converter.

Preferably, the optical transmitting and outputting device has at least a fiber for transmitting and at least a light pen for outputting.

Preferably, the transmitting and outputting device is connected to the laser resonator system by means of a fiber pigtail.

Preferably, the laser system further includes at least a second coupling lens to coincide the laser beam from the wavelength converter to the optical transmitting and outputting device.

Preferably, the second coupling lens is connected with the optical transmitting and outputting device by means of a fiber pigtail.

Preferably, the wavelength converter has at least a QPM crystal.

Preferably, the wavelength converter includes at least a QPM crystal and a temperature controller to adjust the QPM crystal at a specific temperature.

Preferably, the wavelength converter has at least a QPM crystal and a micro-translation device to select a grating period from a grating of the QPM crystal for nonlinear converting.

Preferably, the wavelength converter has at least a QPM crystal, a temperature controller to adjust the QPM crystal at a specific temperature and a micro-translation device to select a grating period from a grating of the QPM crystal for nonlinear converting.

Preferably, the wavelength converter utilizes a QPM-optical parametric generator (QPM-OPG) to emit a laser beam with at least a specific wavelength and a specific power adapted to the PDT and the PDD.

Preferably, the wavelength converter utilizes a QPM-OPG series-connected with another nonlinear wavelength converter to convert the specific wavelength of the laser beam to emit a laser beam with at least a specific wavelength and a specific power adapted to the PDT and the PDD.

Preferably, the nonlinear wavelength converter is fabricated by means of second harmonic generation (SHG).

Preferably, the nonlinear wavelength converter is fabricated by means of sum frequency generation (SFG).

Preferably, the wavelength converter includes a first QPM crystal as an OPG gain medium and at least a second QPM crystal as a nonlinear converting medium.

Preferably, the QPM crystal is a periodically poled lithium niobate (PPLN) crystal.

Preferably, the wavelength converter is a monolithic QPM crystal having multi gratings connected in parallel as an OPG gain medium.

Preferably, each of the gratings of the QPM crystal further has a plurality of grating periods as an OPG gain medium.

Preferably, the wavelength converter is a monolithic QPM crystal having a plurality of series-connected grating periods, in which a first grating period is a QPM-OPG gain medium and another is a nonlinear converting medium.

Preferably, the pumping laser is a Nd:YAG laser emitting a laser beam having a wavelength of 1.064 μm to pump the wavelength converter and the monolithic QPM crystal is a PPLN crystal having a first grating period with 29.7-μm period and a second grating period with a 11.3-μm period.

Preferably, the pumping laser is a Nd:YVO₄ emitting a laser beam having a wavelength of 1.064 μm to pump the wavelength converter and the monolithic QPM crystal is a PPLN crystal having a first grating with a 29.7-μm period and a second grating with a 11.3-μm period.

Preferably, the pumping laser is a Nd:YAG laser emitting a laser beam having a wavelength of 1.064 μm to pump the wavelength converter and the monolithic QPM crystal is a PPLN crystal having a first grating with a 30.5-μm m period and a second grating with a 12.4-μm period.

Preferably, the pumping laser is a Nd:YVO₄ emitting a laser beam having a wavelength of 1.064 μm to pump the wavelength converter and the monolithic QPM crystal is a PPLN crystal having a first grating with a 30.5-μm period and a second grating with a 12.4-μm period.

Preferably, the pumping laser is a Nd:YAG laser emitting a laser beam having a wavelength of 1.064 μm to pump the wavelength converter and the monolithic QPM crystal is a PPLN crystal having a first grating period in a range of 29.7˜30.5 μm, a second grating with a 11.3-μm period and a third grating with a 12.4μm period.

Preferably, the pumping laser is a Nd:YVO₄ emitting a laser beam having a wavelength of 1.064 μm to pump the wavelength converter and the monolithic QPM crystal is a PPLN crystal having a first grating in a range of 29.7˜30.5 μm, a second grating with a 11.3μm period and a third grating with a 12.4μm period.

Preferably, the pumping laser is a Nd:YAG laser emitting a laser beam having a wavelength of 1.064 μm to pump the wavelength converter and the monolithic QPM crystal have two parallel-connected gratings, in which a first nonlinear wavelength converter has a first grating with a 29.7μm period, a second grating with a 11.3μm period and a second nonlinear converter has a first grating with a 30.5μm period and a second grating with a 12.4μm period.

Preferably, the pumping laser is a Nd:YVO₄ emitting a laser beam having a wavelength of 1.064 μm to pump the wavelength converter and the monolithic QPM crystal have two parallel-connected gratings, in which a first nonlinear wavelength converter has a first grating with a 29.7 μm, a second grating with a 11.3 μm period and a second nonlinear wavelength converter has a first grating with a 30.5-μm period and a second grating with a 12.4-μm period.

According to another aspect of the present invention, a laser system especially for a laser source used in the PDT and the. PDD includes: a pump laser emitting at least one laser beam with a specific wavelength to pump a wavelength converter inside a laser resonator system; a wavelength converter using a QPM technique to convert the wavelength of the laser beam emitted by the pump laser into a wavelength adapted to the PDT and the PDD; a laser resonator system, in which combined the wavelength converter, to enhance the intensity of the laser beam; and an optical transmitting and outputting device receiving and transmitting the laser beam for illuminating at least a specific target through an optical outputting device located an end thereof.

In accordance with the present invention, the laser system further includes a first coupling lens located between the pump laser and the wavelength converter for passing therethrough the laser beam.

Preferably, the first coupling lens has an anti-reflecting surface coating, a specific radius of curvature and a specific focal length to receive and coincide the energy of the laser beam from the pump laser to the wavelength converter.

Preferably, the optical transmitting and outputting device has at least a fiber for transmitting and at least a light pen for outputting.

Preferably, the transmitting and outputting device is connected to the laser resonator system by means of a fiber pigtail.

Preferably, the laser system further includes at least a second coupling lens to coincide the laser beam from the wavelength converter to the optical transmitting and outputting device.

Preferably, the second coupling lens is connected with the optical transmitting and outputting device by means of a fiber pigtail.

Preferably, the wavelength converter includes at least a QPM crystal.

Preferably, the wavelength converter includes at least a QPM crystal and a temperature controller to adjust the QPM crystal at a specific temperature.

Preferably, the wavelength converter includes at least a QPM crystal and a micro-translation device to select a period from a multi-grating QPM crystal.

Preferably, the wavelength converter includes at least a QPM crystal, a temperature controller to adjust the QPM crystal at a specific temperature and a micro-translation device to select a period from a grating of the QPM crystal.

Preferably, the laser resonator system is an upright lens system having a pair of optical lenses to emit a laser beam with at least a specific wavelength and power adapted to the PDT and the PDD.

Preferably, the laser resonator system is an upright lens system having an optical lens and a dielectric coated lens suitable for optical reflection and penetration and located at an output facet of a QPM crystal used by the wavelength converter to emit a laser beam with at least a specific wavelength and a specific power adapted to the PDT and the PDD.

Preferably, the laser resonator system is an upright lens system having an optical lens and a dielectric coated lens suitable for optical reflection and penetration and located at a pumping facet of a QPM crystal used by the wavelength converter to emit a laser beam with at least a specific wavelength and a specific power adapted to the PDT and the PDD.

Preferably, the laser resonator system is an upright lens system having a pair of dielectric coated lenses suitable for optical reflection and penetration and respectively located at an output facet and a pumping facet of a QPM crystal used by the wavelength converter to emit a laser beam with at least a specific wavelength and a specific power adapted to the PDT and the PDD.

Preferably, the laser resonator system is a circular lens system having four optical lenses to emit a laser beam with at least a specific wavelength and a specific power adapted to the PDT and the PDD.

Preferably, the laser resonator system utilizes a QPM-optical parametric oscillator (OPO) for converting the specific wavelength of the laser beam to emit a laser beam with at least a specific wavelength and a specific power adapted to the PDT and the PDD.

Preferably, the laser resonator system utilizes a QPM-OPO series-connected with a nonlinear wavelength converter for converting the specific wavelength of the laser beam to emit a laser beam with at least a specific wavelength and a specific power adapted to the PDT and the PDD.

Preferably, the nonlinear wavelength converter is fabricated by means of SHG.

Preferably, the nonlinear wavelength converter is fabricated by means of SFG.

Preferably, the wavelength converter includes a first QPM crystal for an OPO gain medium and at least a second QPM crystal for a nonlinear converting medium.

Preferably, the wavelength converter includes a QPM crystal for an OPO gain medium and at least a nonlinear crystal for a nonlinear converting medium.

Preferably, the QPM crystal is a periodically poled lithium niobate (PPLN) crystal.

Preferably, the wavelength converter is a monolithic QPM crystal which has multi-gratings in parallel for being OPO gain medium.

Preferably, each of the gratings of the QPM crystal further has a plurality of grating periods for an OPO gain medium.

Preferably, the wavelength converter is a monolithic QPM crystal having a plurality of series-connected grating periods, in which a first grating period is a QPM-OPO gain medium and another is a nonlinear converting medium.

Preferably, the pumping laser is a Nd:YAG laser emitting a laser beam having a wavelength of 1.064 μm to pump the wavelength converter and the monolithic QPM crystal is a PPLN crystal having a first grating wiht a 29.7-μm period and a second grating with a 11.3-μm period.

Preferably, the pumping laser is a Nd:YVO₄ laser emitting a laser beam having a wavelength of 1.064 μm to pump the wavelength converter and the monolithic QPM crystal is a PPLN crystal having a first grating with a 29.7-μm period and a second grating with a 11.3-μm period.

Preferably, the pumping laser is a Nd:YAG laser emitting a laser beam having a wavelength of 1.064 μm to pump the wavelength converter and the monolithic QPM crystal is a PPLN crystal having a first grating with a 30.5-μm period and a second grating with a 12.4-μm period.

Preferably, the pumping laser is a Nd:YVO₄ emitting a laser beam having a wavelength of 1.064 μm to pump the wavelength converter and the monolithic QPM crystal is a PPLN crystal having a first grating with a 30.5-μm period and a second grating with a 12.4-μm period.

Preferably, the pumping laser is a Nd:YAG laser emitting a laser beam having a wavelength of 1.064 μm to pump the wavelength converter and the monolithic QPM crystal is a PPLN crystal having a first grating period in a range of 29.7˜30.5 μm, a second grating with a 11.3-μm period and a third grating with a 12.4-μm period.

Preferably, the pumping laser is a Nd:YVO₄ emitting a laser beam having a wavelength of 1.064 μm to pump the wavelength converter and the monolithic QPM crystal is a PPLN crystal having a first grating period in a range of 29.7˜30.5 μm, a second grating with a 11.3-μm period and a third grating with a 12.4-μm period.

Preferably, the pumping laser is a Nd:YAG laser emitting a laser beam having a wavelength of 1.064 μm to pump the wavelength converter and the monolithic QPM crystal have two parallel-connected gratings, in which the first nonlinear wavelength converter has a first grating with a 29.7-μm period, a second grating with a 11.3-μm period and the second nonlinear wavelength converter has a first grating with a 30.5-μm period and a second grating with 12.4-μm period.

Preferably, the pumping laser is a Nd:YVO₄ emitting a laser beam having a wavelength of 1.064 μm to pump the wavelength converter and the monolithic QPM crystal have two parallel-connected gratings, in which the first nonlinear wavelength converter has a first grating with a 29.7-μm period, a second grating with a 11.3-μm period and the second nonlinear wavelength converter has a first grating with a 30.5-μm period and a second grating with 12.4-μm period

According to another aspect of the present invention, a laser system especially for a laser source used in the PDT and the PDD includes: a pump laser emitting at least one laser beam with a specific wavelength to pump a wavelength converter inside a laser resonator system; a laser gain medium absorbing the laser beam emitted by the pump laser for being excited to emit a second laser beam with a second specific wavelength; a wavelength converter using a QPM technique to convert the wavelength of the laser beam emitted by the pump laser into a wavelength adapted to the PDT and the PDD; a laser resonator system, in which combined the wavelength converter, to enhance intensity of the laser beam; and an optical transmitting and outputting device receiving and transmitting the laser beam for illuminating at least a specific target through an optical outputting device located an end thereof.

In accordance with the present invention, the laser system further includes a first coupling lens located between the pump laser and the wavelength converter for passing therethrough the laser beam.

Preferably, the first coupling lens has an anti-reflecting surface coating, a specific curvature and a specific focal distance to receive and coincide the energy of the laser beam from the pump laser to the wavelength converter.

Preferably, the optical transmitting and outputting device has at least a fiber for transmitting and at least a light pen for outputting.

Preferably, the transmitting and outputting device is connected to the laser resonator system by means of a fiber pigtail.

Preferably, the laser system further includes at least a second coupling lens to coincide the laser beam from the wavelength converter to the optical transmitting and outputting device.

Preferably, the second coupling lens is connected with the optical transmitting and outputting device by means of a fiber pigtail.

Preferably, the wavelength converter includes at least a QPM crystal.

Preferably, the wavelength converter includes at least a QPM crystal and a temperature controller to adjust the QPM crystal at a specific temperature.

Preferably, the wavelength converter includes at least a QPM crystal and a micro-translation device to select a period from a multi-grating QPM crystal.

Preferably, the wavelength converter includes at least a QPM crystal, a temperature controller to adjust the QPM crystal at a specific temperature and a micro-translation device to select a grating period from a multi-grating QPM crystal.

Preferably, the laser resonator system is an upright lens system having a pair of optical lenses to emit a laser beam with at least a specific wavelength and a specific power adapted to the PDT and the PDD.

Preferably, the laser resonator system is an upright lens system having an optical lens and a dielectric coated lens suitable for optical reflection and penetration and located at an output facet of a QPM crystal used by the wavelength converter to emit a laser beam with at least a specific wavelength and a specific power adapted to the PDT and the PDD.

Preferably, the laser resonator system is an upright lens system having an optical lens and a dielectric coated lens suitable for optical reflection and penetration and located at a pumping facet of the laser gain medium used by the wavelength converter to emit a laser beam with at least a specific wavelength and a specific power adapted to the PDT and the PDD.

Preferably, the laser resonator system is an upright lens system having a pair of dielectric coated lenses suitable for optical reflection and penetration and separately located at a pumping facet of the laser gain medium and an output facet of a QPM crystal used by the wavelength converter to emit a laser beam with at least a specific wavelength and a specific power adapted to the PDT and the PDD.

Preferably, the laser resonator system is an non-coaxial laser resonator system having an upright laser resonator system coupled with an optical lens external to the upright resonator system for resonator the laser gain medium to emit a laser beam with a third specific wavelength.

Preferably, the external optical lens is a lens coated by a dielectric and located at a pumping facet of the laser gain medium.

Preferably, the laser resonator system is a circular lens system having four optical lenses to emit a laser beam with at least a specific wavelength and a specific power adapted to the PDT and the PDD.

Preferably, the laser resonator system utilizes a QPM- optical parametric oscillator (OPO) for converting the specific wavelength of the laser beam to emit a laser beam with at least a specific wavelength and a specific power adapted to the PDT and the PDD.

Preferably, the laser resonator system utilizes a QPM-OPO series-connected with a nonlinear wavelength converter for converting the specific wavelength of the laser beam to emit a laser beam with at least a specific wavelength and a specific power adapted to the PDT and the PDD.

Preferably, the nonlinear wavelength converter is fabricated by means of SHG.

Preferably, the nonlinear wavelength converter is fabricated by means of SFG.

Preferably, the wavelength converter includes a first QPM crystal for an OPO gain medium and at least a second QPM crystal for a nonlinear converting medium.

Preferably, the wavelength converter includes a QPM crystal for an OPO gain medium and at least a nonlinear crystal for a nonlinear converting medium.

Preferably, the QPM crystal is a periodically poled lithium niobate (PPLN) crystal.

Preferably, the wavelength converter is a monolithic QPM crystal having a plurality of gratings connected in parallel for being OPO gain media.

Preferably, each of the gratings of the QPM crystal further comprises a plurality of grating periods for an OPO gain medium.

Preferably, the wavelength converter is a monolithic QPM crystal having a plurality of series-connected grating periods, in which a first grating period is a QPM-OPO gain medium and another is a nonlinear converting medium.

Preferably, the pumping laser is a semiconductor emitting a wavelength of 808 nm to pump the laser gain medium, a Nd:YAG crystal, which emitting a laser beam having a wavelength of 1.064 μm, to pump the wavelength converter and the monolithic QPM crystal is a PPLN crystal having a first grating with a 29.7-μm period and a second grating with a 11.3-μm period.

Preferably, the pumping laser is a semiconductor emitting a wavelength of 809 nm to pump the laser gain medium, a Nd:YVO₄ crystal, which emitting a laser beam having a wavelength of 1.064 μm, to pump the wavelength converter and the monolithic QPM crystal is a PPLN crystal having a first grating with a 29.7-μm period and a second grating with a 11.3-μm period.

Preferably, the pumping laser is a semiconductor emitting a wavelength of 808 nm to pump the laser gain medium, a Nd:YAG crystal, which emitting a laser beam having a wavelength of 1.064 μm, to pump the wavelength converter and the monolithic QPM crystal is a PPLN crystal having a first grating with a 30.5-μm period and a second grating with a 12.4-μm period.

Preferably, the pumping laser is a semiconductor emitting a wavelength of 809 nm to pump the laser gain medium, a Nd:YVO₄ crystal, which emitting a laser beam having a wavelength of 1.064 μm, to pump the wavelength converter and the monolithic QPM crystal is a PPLN crystal having a first grating with a 30.5-μm period and a second grating with a 12.4-μm period.

Preferably, the pumping laser is a semiconductor emitting a wavelength of 808 nm to pump the laser gain medium, a Nd:YAG crystal, which emitting a laser beam having a wavelength of 1.064 μm, to pump the wavelength converter and the monolithic QPM crystal is a PPLN crystal having a first grating period in a range of 29.7˜30.5 μm, a second grating with a 11.3-μm period and a third grating with a 12.4-μm period.

Preferably, the pumping laser is a semiconductor emitting a wavelength of 809 nm to pump the laser gain medium, a Nd:YVO₄ crystal, which emitting a laser beam having a wavelength of 1.064 μm, to pump the wavelength converter and the monolithic QPM crystal is a PPLN crystal having a first grating period in a range of 29.7˜30.5 μm, a second grating with a 11.3-μm period and a third grating with a 12.4-μm period.

Preferably, the pumping laser is a semiconductor emitting a wavelength of 808 nm to pump the laser gain medium, a Nd:YAG crystal, which emitting a laser beam having a wavelength of 1.064 μm, to pump the wavelength converter and the monolithic QPM crystal have two parallel-connected gratings, in which the first optical grating has a first grating with a 29.7-μm period, a second grating with a 11.3-μm period and the second optical grating has a first grating with a 30.5-μm period and a second grating with a 12.4-μm period.

Preferably, the pumping laser is a semiconductor emitting a wavelength of 809 nm to pump the laser gain medium, a Nd:YVO₄ crystal, which emitting a laser beam having a wavelength of 1.064 μm, to pump the wavelength converter and the monolithic QPM crystal have two parallel-connected gratings, in which the first optical grating has a first grating with a 29.7-μm period, a second grating with a 11.3-μm period and the second optical grating has a first grating with a 30.5-μm period and a second grating with a 12.4-μm period.

The foregoing and other features and advantages of the present invention will be more clearly understood through the following descriptions with reference to the drawings, wherein:

### BRIEF DESCRIPTION OF THE DRAWINGS

FIG. 1 is a diagram illustrating the laser system for the PDT and the PDD of the present invention;

FIG. 2 is a diagram illustrating the structure of the QPM crystal in the laser system for the PDT and the PDD according to a first preferred embodiment of the present invention;

FIG. 3 is a diagram illustrating the structure of the QPM crystal in the laser system for the PDT and the PDD according to a second preferred embodiment of the present invention;

FIG. 4 is a diagram illustrating the structure of the QPM crystal in the laser system for the PDT and the PDD according to a third preferred embodiment of the present invention;

FIG. 5 is a diagram illustrating the laser system for the PDT and the PDD according to a first preferred embodiment of the present invention;

FIG. 6 is a diagram illustrating the laser system for the PDT and the PDD according to a second preferred embodiment of the present invention;

FIG. 7 is a diagram illustrating the laser system for the PDT and the PDD according to a third preferred embodiment of the present invention; and

FIG. 8 is a diagram illustrating the laser system for the PDT and the PDD according to a fourth preferred embodiment of the present invention.

### DETAILED DESCRIPTION OF THE PREFERRED EMBODIMENT

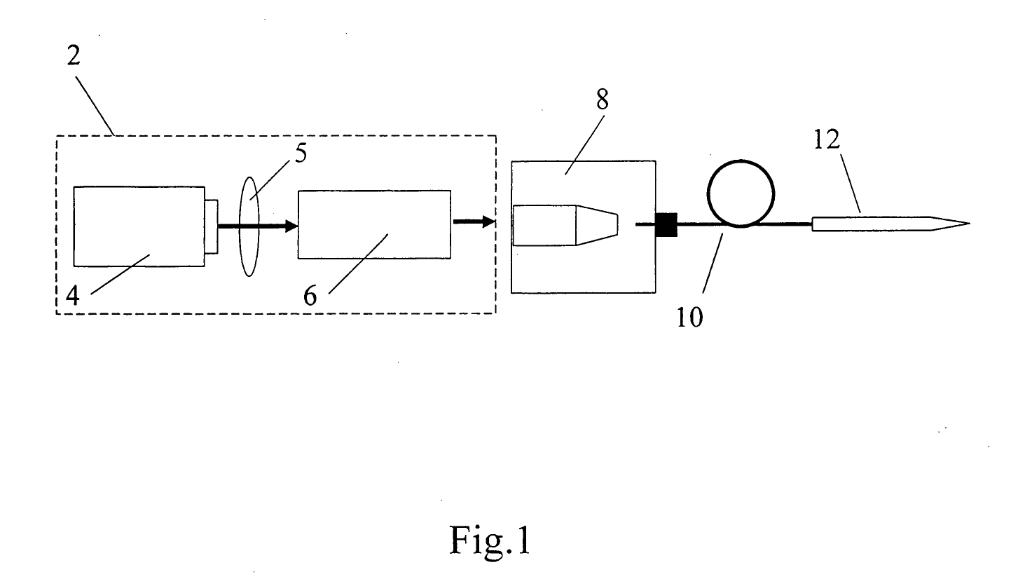

The present invention will now be described more specifically with reference to the following embodiments. Please refer to FIG. 1. FIG. 1 is a diagram illustrating the laser system for the photodynamic therapy (PDT) and the photodynamic diagnosis (PDD) of the present invention. The laser system includes at least one laser system 2, the coupling lens system 8 and the optical transmitting and outputting device. The optical transmitting and outputting device includes the fiber 10 and the light pen 12. The laser device 2 includes the pump laser 4, the coupling lens 5 and the wavelength converter 6. The wavelength converter 6 is used to convert a specific wavelength emitted by the pump laser 4 into at least one another specific wavelength adapted to the PDT and PDD. The laser beam having the converted wavelength is focused by the coupling lens system 8, passes through the fiber 10 and is finally output by the light pen 12 of the optical transmitting and outputting device for illuminating at a specific target, such as a tumor tissue which is given a photosensitive medicine. Furthermore, the coupling lens system 8 is able to be left out in the laser system 2 for the PDT and PDD, which is directly connected to the optical transmitting and outputting device by means of a fiber pigtail.

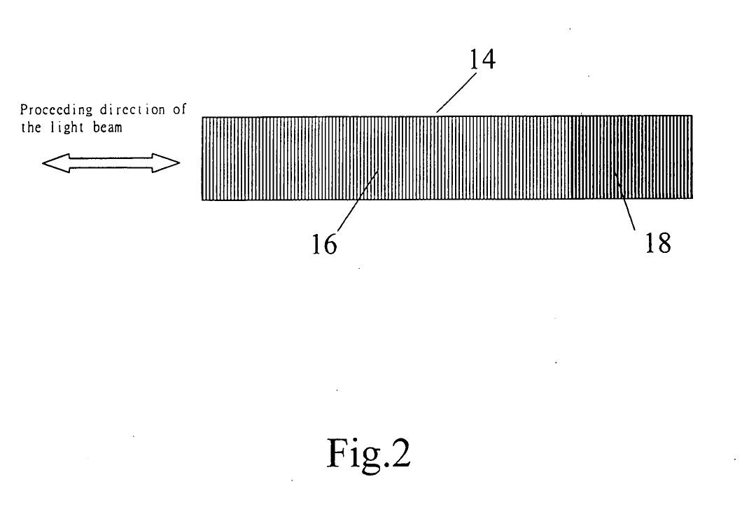

Please refer to FIG. 2. FIG. 2 is a diagram illustrating the QPM crystal of the wavelength converter 6 in the laser system for the PDT and the PDD according to a first preferred embodiment of the present invention. The QPM crystal 14 is monolithic and has the first grating period 16 series connected with the second grating period 18. The wavelength of the laser beam emitted by the pump laser 4 is continuously nonlinear converted by the grating periods into at least one specific wavelength adapted to the PDT and the PDD. According to a preferred embodiment of the present invention, the QPM crystal 14 is a periodically poled lithium niobate (PPLN) crystal having the first grating 16 with a 29.7-μm period for being an optical parametric generator (OPG) gain medium. In which, the OPG emits a laser signal having a wavelength of 1562.7 nm accompanying with an idler laser beam having a wavelength of 3334.1 nm. The second grating 18 with a 11.3-μm period is a nonlinear optical medium, which emits a signal laser having a wavelength of 633 nm by sum frequency generation (SFG) of the pumping laser having a wavelength of 1064 nm and the signal laser having a wavelength of 1562.7 nm from the first grating 16. The signal laser having a wavelength of 633 nm is suitable for exciting a photosensitive medicine, such as ALA (5-aminolevulinic) and PhotofrinR, used in the PDT. Additionally, the first grating 16 with a 30.5-μm period for being an OPG emits a laser signal having a wavelength of 1683.8 nm, and the second grating 18 with a 12.4-μm period for being a nonlinear optical medium emits a signal laser having a wavelength of 652 nm by SFG of the pumping laser and signal laser, which is suitable for exciting another photosensitive medicine of Foscan which is used in the PDT.

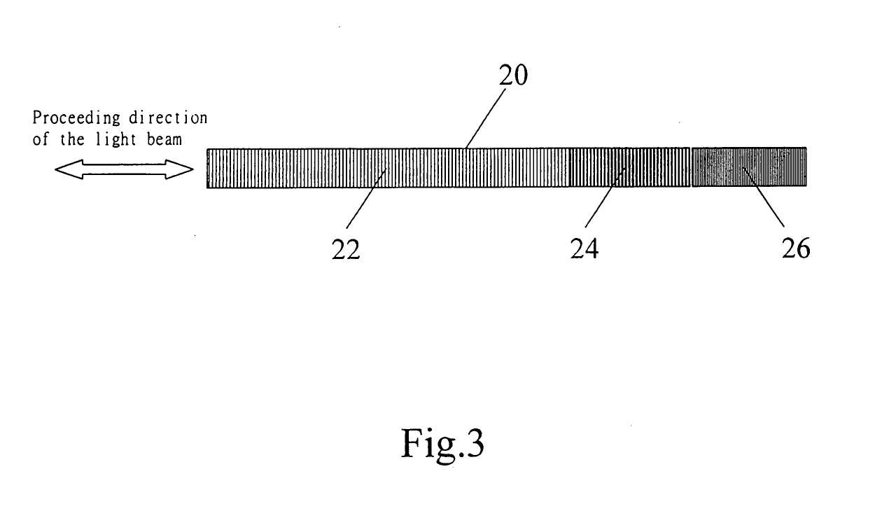

Please refer to FIG. 3, which illustrates the QPM crystal of the wavelength converter 6 in the laser system for the PDT and the PDD according to a second preferred embodiment of the present invention. The QPM crystal 20 is monolithic and has the first grating 22, the second grating 24 and the third grating 26. The wavelength of the laser beam emitted by the pump laser 4 is continuously nonlinear converted by the grating periods into at least one specific wavelength adapted to the PDT and the PDD. According to a preferred embodiment of the present invention, the QPM crystal 20 is a PPLN crystal having the first grating period 22 of 29.7˜30.5 μm for being an OPG gain medium. In which, the OPG emits a first laser signal having a wavelength of 1562.7 nm at the first temperature and a second laser signal having a wavelength of 1683.8 nm at the second temperature accompanying with idler laser beams having a wavelength of 3334.1 nm and 2890.6 nm respectively. The second grating 24 with a 11.3-μm period is a nonlinear optical medium, which emits a signal laser having a wavelength of 633 nm by the SFG of the pumping laser having a wavelength of 1064 nm and the signal laser having a wavelength of 1562.7 nm at the first temperature from the first grating 22. The third grating 26 with a 12.4 μm is a nonlinear optical medium, which emits a signal laser having a wavelength of 652 nm by the SFG of the pumping laser having a wavelength of 1064 nm and the signal laser having a wavelength of 1683.8 nm at the second temperature from the second grating 24. The signal laser having wavelengths of 633 nm and 652 nm is suitable for being used in the PDT.

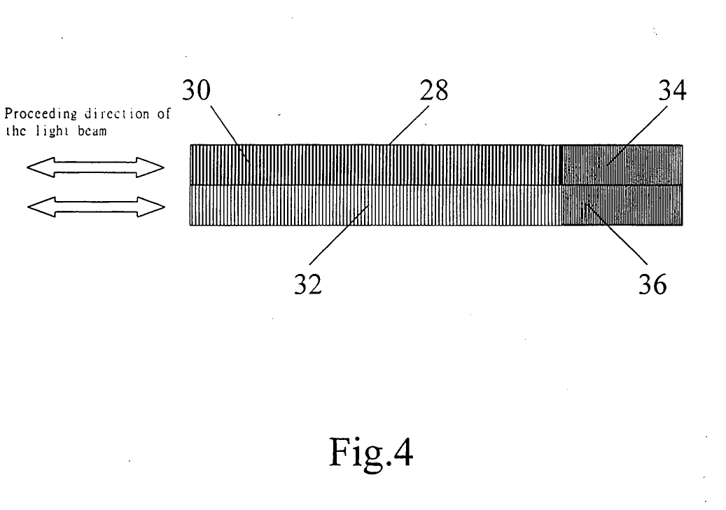

Please refer to FIG. 4, which illustrates the QPM crystal of the wavelength converter in the laser system for the PDT (Photodynamic Therapy) and the PDD (Photodynamic Diagnosis) according to a third preferred embodiment of the present invention. The QPM crystal 28 is monolithic and has a plurality of grating periods connected in parallel. Apparently, the effect, the principle and the application for each of the plurality of grating periods are the same with those in the QPM crystal 14 and have been thoroughly described. According to a preferred embodiment of the present invention, the QPM crystal 28 has two parallel-connected gratings. In which the first optical grating has a first grating 30 with a 29.7-μm period and a second grating 34 with a 11.3-μm period, while the second optical grating has the first grating 32 with a 30.5-μm period and the second grating 36 with a 12.4-μm period. Based on the above, when a laser beam having a wavelength of 1064 μm emitted by the pump laser 4 incidents into the QPM crystal 28, the laser beams having the second specific wavelength of 633 nm and the third specific wavelength of 652 nm will be generated and emitted respectively by the first and the second row of the gratings. Furthermore, the laser beam having a plurality of wavelengths adapted to the PDT and the PDD can emit from the QPM crystal 28, since the QPM crystal 28 has a plurality of parallel-connected QPM crystals 14 having a plurality of series-connected gratings.

Owning to the QPM capacities of being designed and processed, the QPM crystals 14, 20 and 28 are able to convert each wavelength into another specific wavelength adapted to the PDT and the PDD by means of designing and processing through the QPM crystal. Therefore, the present invention provides a laser source with high quality of emitting a laser beam having a suitable power and a specific wavelength for the PDT and the PDD. That is, the drawbacks of having the laser beam with particular wavelengths only and having inadequate nonlinear converting ability to convert the wavelength of laser beam in the conventional art are overcome in the present invention. Accordingly, the accuracy and sensitivity of the diagnosis and the scope and profundity of the therapy are improved.

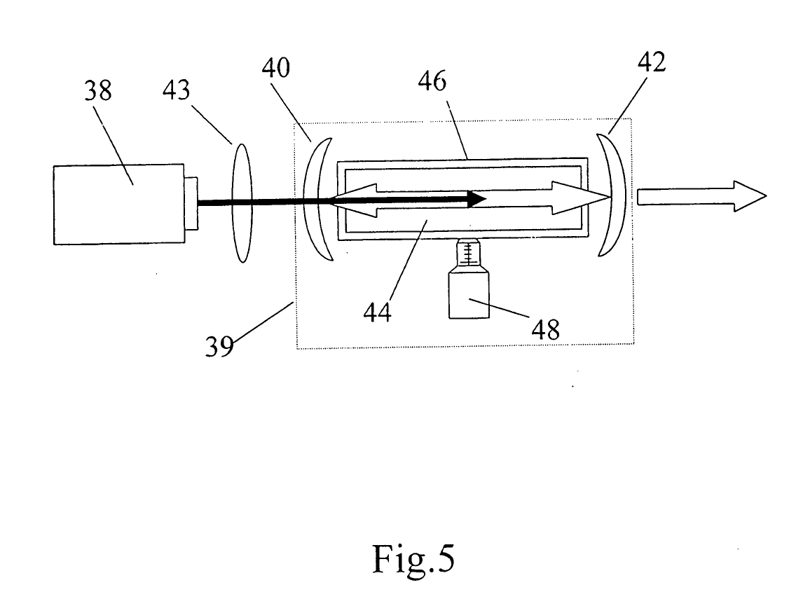

Please refer to FIG. 5 to FIG. 8, which are diagrams illustrating the laser system 2 for the PDT and the PDD according to preferred embodiments of the present invention. According to the foregoing descriptions, the laser system 2 includes the pump laser 4 and the wavelength converter 6. The structure according to the former embodiment, of the wavelength converter 6 used for converting the specific wavelength of the laser beam emitted from the pump laser 4 into the other specific wavelength adapted to be used in the PDT and PDD includes the QPM crystals 14, 20 and 28. According to the preferred embodiments shown in FIG. 5 to FIG. 8, each of the wavelength converters 39, 51, 63 and 79 in the laser system 2 further include a laser resonator system to enhance the intensity of the laser beam respectively emitted by each of the pump laser 38, 50, 62 and 78. The laser beams pass through the QPM crystals 44, 56, 72 and 90 respectively and coincided by the coupling lens 43, 55, 71 and 87. As a result, the wavelengths are converted and the optical intensity is enhanced for generating the laser beam adapted to the PDT and PDD.

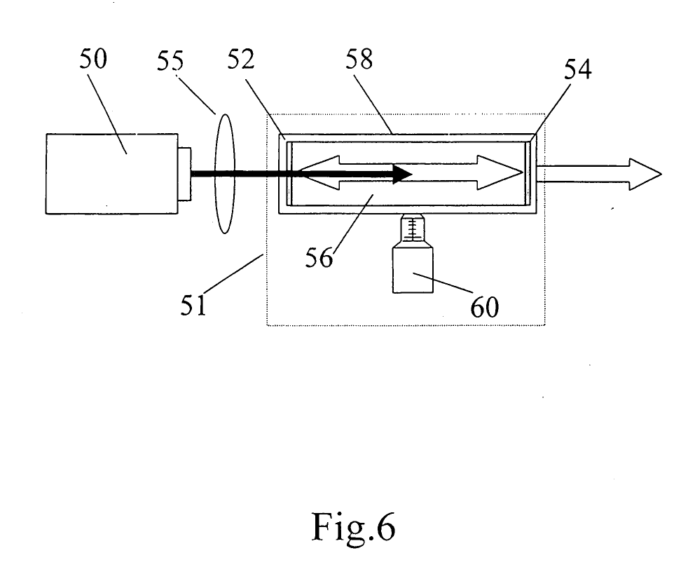

As shown in FIG. 5, the laser resonator system is an upright lens system including a pair of optical lenses 40 and 42. Additionally, the laser resonator system can also be an upright lens system including a pair of dielectric coated lenses 52 and 54 suitable for optical reflection and penetration. The dielectric coated lenses 52 and 54 are respectively located at an output facet and a pumping facet of the QPM crystal 56 used by the wavelength converter 51, as shown in FIG. 6.

The laser beams emitted by the pump lasers 38 and 50 are coincided by the coupling lens 43 and 55, converted by the QPM crystals 44 and 56 and then resonated by the laser resonator system, respectively. The converting process related to a nonlinear converting is stated in the above description and needs not to be repeated. Furthermore, the QPM crystals 44 and 56 are respectively located on the temperature controller 46 and 58 to. adjust the QPM crystals 44 and 56 to a specific temperature. The temperature controller 46 and 58 are further respectively located on a transmission plane of the micro-translation devices 48 and 60. The grating periods of the QPM crystals 44 and 56 are pumped in a proper order to emit the laser beams having a plurality of wavelengths adapted to the PDT and the PDD.

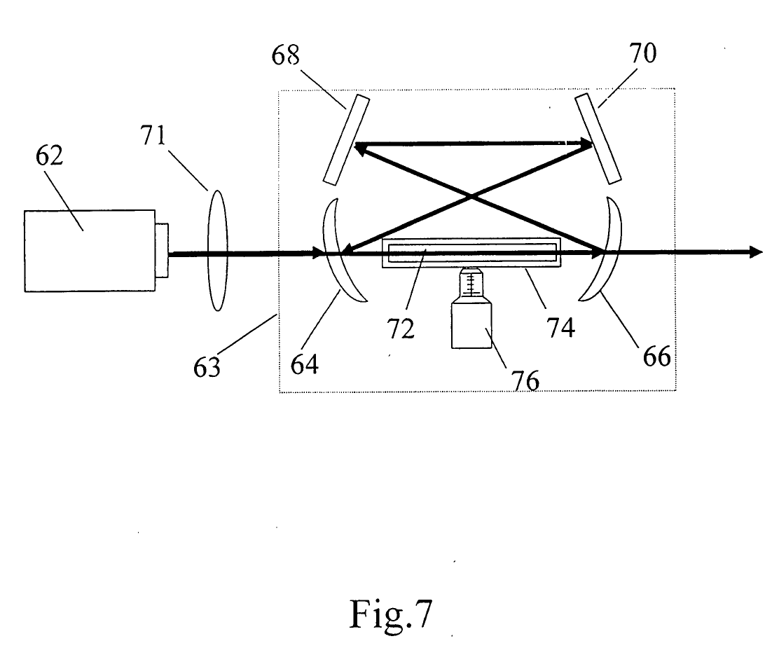

Please refer to FIG. 7, which is a diagram illustrating the laser system 2 for the PDT and the PDD according to a third preferred embodiment of the present invention. The wavelength converter 63 having a circular laser resonator system which has four optical lenses 64, 66, 68 and 70, is able to resonate at least one laser beam emitted by the pump laser 62 and converted by the QPM crystal 72 in a single direction. With regard to the effects, principles and applications of the pump laser 62, the coupling lens 72, the temperature controller 74 and the micro-translation device 76 in this embodiment are the same with those of the foregoing and therefore not repeated.

Comparing the upright and the circular lens system, the upright lens system has a less loss and a lower pumping valve value owing to its simpler structure. Besides, the system loss and the pumping valve value of the circular resonator system are higher because of its complicated structure consisting of the four laser optical lenses. However, the laser beam emitted from the circular lens system can have a higher quality and a ten-times smaller linewidth of the laser than that of the laser emitted from the upright system.

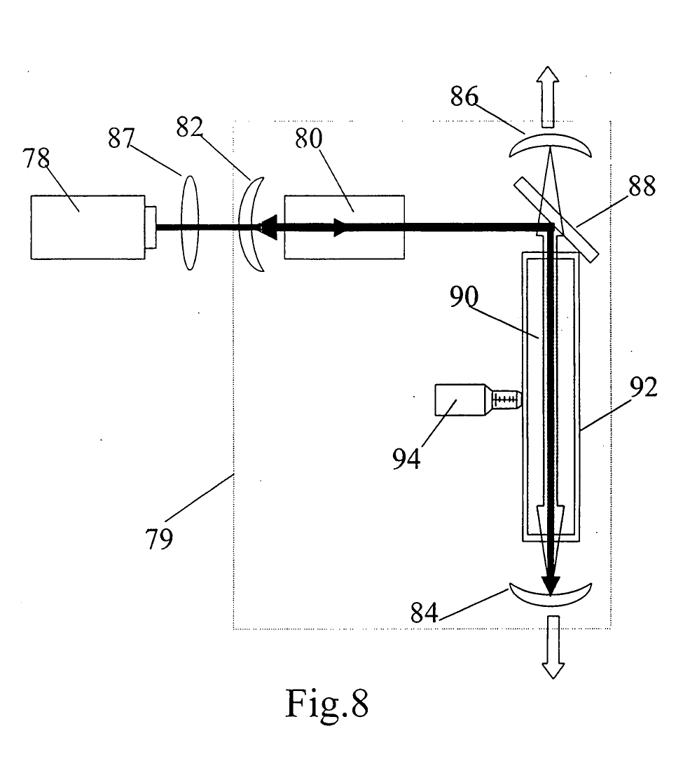

Referring to FIG. 8, which is a diagram illustrating the laser system 2 for the PDT and the PDD according to a fourth preferred embodiment of the present invention. The wavelength converter 79 is a non-coaxial laser resonator device having an upright laser resonator device which has a pair of optical lenses 84 and 86, coupled with the optical lens 82. In which the optical lens 82 has a position external to the upright resonator device. The non-coaxial laser resonator system is used to resonate a laser beam which is emitted by the pump laser 78 and generated from the laser gain medium 80. The laser beam with a specific wavelength is reflected by the specific mirror 88, passes through the upright laser resonator system and then turns to the direction of the axial of the upright laser resonator system for pumping the QPM crystal 90 to emit the laser beam having at least one wavelength adapted to the PDT and the PDD. The power of the laser beam can also be enhanced in the upright laser resonator system. With regard to the effects, the principles and the applications of the coupling lens 90, the temperature controller 92 and the micro-translation device 94 in this embodiment are the same with those of the foregoing and therefore not repeated.

Besides, because the QPM crystal 90 is pumped inside the laser resonator system, the power needed for pumping of the non-coaxial system is lower. As a result, the converting efficiency will be higher than the other QPM crystals used in the wavelength convert according to the embodiments shown in FIG. 5 to FIG. 7. However, the structure of the non-coaxial system is more complicated for its non-coaxial resonator system and therefore, the optical collation is much more difficult.

According to a preferred embodiment of the present invention, the pump lasers 38, 50 and 62 can emit a laser beam having a wavelength of 1064 nm and a power of about 11W. Additionally, the pump laser 78 is a semiconductor emitting a laser beam having a wavelength of 808 nm and , ,a power of 25W. The laser gain medium 80 is a Nd:YAG laser crystal. The. QPM crystals 44, 56, 72 and 90 respectively used in the wave converters 39, 51, 63 and 79 can have a structure, which is the same with the QPM crystal 14. The laser beam for the PDD and the PDT, which has the wavelength of 633 nm and the power of 2 W is emitted by the laser system 2 when the QPM crystal has the first grating period 16 of 29.7 μm with a length of 5 cm and the second grating period 18 of 11.3 μm with a length of 1 cm.

According to the above, the laser system using a QPM technique to emit a laser beam, which has a convertible and adjustable wavelength is provided in the present invention. The optical intensity can be enhanced by the meticulously designed laser resonator system, which is actually suitable for the PDT and the PDD and also meet the demands for the accuracy and sensitivity of the diagnosis and the scope and profundity of the therapy. Hence, the present invention not only has a novelty and a progressive nature, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A laser system which is a coherent light source used in one of a photodynamic therapy (PDT) and a photodynamic diagnosis (PDD), comprising:
a pump laser emitting at least a laser beam with a specific wavelength;
a wavelength converter converting said specific wavelength of said laser beam emitted by said pump laser into a wavelength adapted to said PDT and said PDD; and
an optical transmitting and outputting device receiving and transmitting said laser beam for illuminating at least a specific target through an optical outputting device located an end thereof.

2. The laser system according to claim 1 further comprising a first coupling lens located between said pump laser and said wavelength converter for passing therethrough said laser beam.

3. The laser system according to claim 2, wherein said first coupling lens has an anti-reflecting surface coating, a specific curvature and a specific focal length to receive and coincide an energy of said laser beam from said pump laser to said wavelength converter.

4. The laser system according to claim 1, wherein said optical transmitting and outputting device comprises at least a fiber for transmitting and at least a light pen for outputting.

5. The laser system according to claim 4, wherein said transmitting and outputting device is connected to said wavelength converter by means of a fiber pigtail.

6. The laser system according to claim 1 further comprising at least a second coupling lens to coincide said laser beam from said wavelength converter to said optical transmitting and outputting device.

7. The laser system according to claim 6, wherein said second coupling lens is connected with said optical transmitting and outputting device by means of a fiber pigtail.

8. The laser system according to claim 1, wherein said wavelength converter comprises at least a quasi-phase matching (QPM) crystal.

9. The laser system according to claim 8, wherein said wavelength converter further comprises a temperature controller to adjust said QPM crystal at a specific temperature.

10. The laser system according to claim 9, wherein said wavelength converter further comprises a micro-translation device to select a grating period from a multi-grating of said QPM crystal.

11. The laser system according to claim 8, wherein said wavelength converter further comprises a micro-translation device to select a grating period from a multi-grating of said QPM crystal.

12. The laser system according to claim 8, wherein said QPM crystal is a periodically poled lithium niobate (PPLN) crystal.

13. The laser system according to claim 1, wherein said wavelength converter utilizes one of a QPM-optical parametric generator (OPG) and a QPM-OPG series-connected with a nonlinear wavelength converter to convert said specific wavelength of said laser beam.

14. The laser system according to claim 13, wherein said nonlinear wavelength converter is fabricated by one of a second harmonic generation (SHG) and a sum frequency generation (SFG).

15. The laser system according to claim 13, wherein said wavelength converter is a monolithic QPM crystal having a plurality of gratings connected in parallel for being an OPG gain medium for said QPM-OPG.

16. The laser system according to claim 15, wherein each of said gratings further comprises multi grating periods for an OPG gain medium.

17. The laser system according to claim 13, wherein said QPM-OPG series-connected with a nonlinear wavelength converter comprises a plurality of series-connected grating periods, in which a first grating period is a QPM-OPG gain medium and another is a nonlinear converting medium.

18. The laser system according to claim 13, wherein said QPM-OPG series-connected with a nonlinear wavelength converter comprises a first QPM crystal for an OPG gain medium and at least a second QPM crystal for a nonlinear converting medium.

19. The laser system according to claim 13, wherein said QPM-OPG series-connected with a nonlinear wavelength converter comprises a QPM crystal for an OPG gain medium and at least a nonlinear crystal for a nonlinear converting medium.

20. The laser system according to claim 1, wherein said pump laser is one of a Nd:YAG laser and a Nd:YVO₄ laser for emitting a laser beam with a wavelength of 1.064 μm.

21. A laser system for a laser source used in one of a PDT and a PDD, comprising:
a pump laser emitting at least a laser beam with a specific wavelength;
a wavelength converter wavelength converter converting said specific wavelength of said laser beam emitted by said pump laser into a wavelength adapted to said PDT and said PDD; and
a laser resonator system, in which combined the wavelength converter, to enhance intensity of the laser beam; and
an optical transmitting and outputting device receiving and transmitting said laser beam for illuminating at least a specific target through an optical outputting device located an end thereof.

22. The laser system according to claim 21 further comprising a first coupling lens located between said pump laser and said resonator device for passing therethrough said laser beam.

23. The laser system according to claim 22, wherein said first coupling lens has an anti-reflecting surface coating, a specific curvature and a specific focal distance to receive and coincide an energy of said laser beam from said pump laser to said resonator device.

24. The laser system according to claim 21, wherein said laser system further comprises at least a second coupling lens to coincide said laser beam from said laser resonator system to said optical transmitting and outputting device.

25. The laser system according to claim 24, wherein said second coupling lens is connected with said optical transmitting and outputting device by means of a fiber pigtail.

26. The laser system according to claim 21, wherein said laser resonator system is an upright lens system comprising a pair of optical lenses.

27. The laser system according to claim 21, wherein said laser resonator system is an upright lens system comprising an optical lens and a dielectric coated lens suitable for optical reflection and penetration and located at an output facet of a QPM crystal used by said wavelength converter.

28. The laser system according to claim 21, wherein said laser resonator system is an upright lens system comprising a pair of dielectric coated lenses suitable for optical reflection and penetration and respectively located at an output facet and a pumping facet of a QPM crystal used by said wavelength converter.

29. The laser system according to claim 21, wherein said laser resonator system is a circular lens system comprising four optical lenses.

30. The laser system according to claim 21, wherein said wavelength converter utilizes one of a QPM-optical parametric oscillator (OPO) and a QPM-OPO series-connected with a nonlinear wavelength converter to convert said specific wavelength of said laser beam.

31. The laser system according to claim 30, wherein said nonlinear wavelength converter is fabricated by one of a SHG and a SFG.

32. The laser system according to claim 30, wherein said wavelength converter is a monolithic QPM crystal having a plurality of gratings connected in parallel for being an OPO gain medium for said QPM-OPO.

33. The laser system according to claim 32, wherein each of said gratings further comprises a plurality of grating periods for an OPO gain medium.

34. The laser system according to claim 30, wherein said QPM-OPO series-connected with a nonlinear wavelength converter comprises a plurality of series-connected grating periods, in which a first grating period is a QPM-OPO gain medium and another is a nonlinear converting medium.

35. The laser system according to claim 30, wherein said QPM-OPO series-connected with a nonlinear wavelength converter comprises a first QPM crystal for an OPO gain medium and at least a second QPM crystal for a nonlinear converting medium.

36. The laser system according to claim 30, wherein said QPM-OPO series-connected with a nonlinear wavelength converter comprises a QPM crystal for an OPO gain medium and at least a nonlinear crystal for a nonlinear converting medium.

37. A laser system for a laser source used in one of a PDT and a PDD, comprising:
a pump laser emitting at least a laser beam with a specific wavelength;
a laser gain medium absorbing said laser beam emitted by said pump laser for being excited to emit a second laser beam with a second specific wavelength;
a wavelength converter wavelength converter converting said specific wavelength of said laser beam emitted by said pump laser into a wavelength adapted to said PDT and said PDD;
a laser resonator system, in which combined the wavelength converter, to enhance intensity of the laser beam; and
an optical transmitting and outputting device receiving and transmitting said laser beam for illuminating at least a specific target through an optical outputting device located an end thereof.

38. The laser system according to claim 37, wherein said laser resonator system is an upright lens system comprising a pair of optical lenses.

39. The laser system according to claim 37, wherein said laser resonator system is an upright lens system comprising an optical lens and a dielectric coated lens suitable for optical reflection and penetration and located at an output facet of a QPM crystal used by said wavelength converter.

40. The laser system according to claim 37, wherein said laser resonator system is an upright lens system comprising an optical lens and a dielectric coated lens suitable for optical reflection and penetration and located at an pumping facet of a laser gain medium used by said wavelength converter.

41. The laser system according to claim 37, wherein said laser resonator system is an non-coaxial laser resonator system comprising an upright laser resonator system coupled with an optical lens external to said upright resonator device for resonator said laser gain medium to emit a laser beam with a third specific wavelength.

42. The laser system according to claim 41, wherein said external optical lens is a lens coated by a dielectric and located at a pumping facet of said laser gain medium.

43. The laser system according to claim 37, wherein said pump laser is a laser having a semiconductor emitting a wavelength of one of 808 nm and 809 nm.

44. The laser system according to claim 37, wherein said laser gain medium is one of Nd:YAG crystal and Nd:YVO₄ crystal.
